(19) United States
(12) Patent Application Publication
(10) Pub. No.: US 2013/0316708 A1
(43) Pub. Date: Nov. 28, 2013

(54) Network Elements, Cellular Communication System and Methods Therefor

(71) Applicant: IP.Access LTD., Cambourne (GB)

(72) Inventor: Ian Ross MacPherson, St. Neots (GB)

(73) Assignee: IP.Access LTD., Cambourne (GB)

(21) Appl. No.: 13/900,628

(22) Filed: May 23, 2013

(30) Foreign Application Priority Data
May 25, 2012 (GB) 1209224.3

(51) Int. Cl. H04W 4/02

(52) U.S. Cl. CPC H04W 4/02
USPC 455/435.1

(57) ABSTRACT

Location presence information is provided to advertising services by a femto-cell management system in a femto/pico-cell environment. On registration of a user equipment with a pico-cell which has been previously identified as a designated zone, the management system sends an alert to the advertising services. A SMS controller permits the advertising services to send a welcome text message including advertising content to the user equipment. The management system can also act as a centralized GSMA one API application gateway for location presence.

### RELATED APPLICATION(S)

This application claims priority to Great Britain Patent Application No. 1209224.3 filed May 25, 2012, which is incorporated by reference herein in their entirety.

### FIELD OF THE INVENTION

The field of this invention relates to network elements, a cellular communication system and methods therefor and particularly to the provision of a location presence service.

### BACKGROUND OF THE INVENTION

Wireless communication systems, such as the 3rd Generation (3G) of mobile telephone standards and technology, are well known. An example of such 3G standards and technology is the Universal Mobile Telecommunications System (UMTS™), developed by the 3rd Generation Partnership Project (3GPP™) (www.3gpp.org). The 3rd generation of wireless communications has generally been developed to support macro-cell mobile phone communications. Such macro cells utilise high power base stations (NodeBs in 3GPP parlance) to communicate with wireless communication units within a relatively large geographical coverage area. Typically, wireless communication units, or User Equipment (UEs) as they are often referred to in 3G parlance, communicate with a Core Network (CN) of the 3G wireless communication system via a Radio Network Subsystem (RNS). A wireless communication system typically comprises a plurality of radio network subsystems, each radio network subsystem comprising one or more cells to which UEs may attach, and thereby connect to the network. Each macro-cellular RNS further comprises a controller, in a form of a Radio Network Controller (RNC), operably coupled to the one or more Node Bs, via a so-called Iub interface.

The second generation wireless communication system (2G), also known as GSM, is a well-established cellular, wireless communications technology whereby “base transceiver stations” (equivalent to the Node B's of the 3G system) and “mobile units” (user equipment) can transmit and receive voice and packet data. Several base transceiver stations are controlled by a Base Station Controller (BSC), equivalent to the RNC of 3G systems.

Lower power (and therefore smaller coverage area) femto-cells (or pico-cells) are a recent development within the field of wireless cellular communication systems. Femto-cells or pico-cells (with the term femto cells being used hereafter to encompass pico-cells or similar) are effectively communication coverage areas supported by low power base stations (otherwise referred to as Access Points (APs) or Home Node B's (HNBs) or evolved Home Node B's (HeNB's). These femto-cells are intended to be able to be piggy-backed onto the more widely used macro-cellular network and support communications to UEs in a restricted, for example ‘in-building’, environment. Each femto-cell (or pico-cell) is I served by one Access Point.

Typical applications for such Access Points include, by way of example, residential and commercial locations, communication ‘hotspots’, etc., whereby Access Points can be connected to a core network via, for example, the Internet using a broadband connection or the like. In this manner, femto cells can be provided in a simple, scalable deployment in specific in-building locations where, for example, network congestion at the macro-cell level may be problematic.

Although there are no standard criteria for the functional components of a HNB (or Access Point), an example of a typical HNB for use within a 3GPP system may comprise Node-B functionality and some aspects of Radio Network Controller (RNC) functionality.

A HNB is an access point that provides a wireless interface for a user equipment connectivity. It provides a radio access network connectivity to a user equipment (UE) using the so-called Iuh interface to a network access controller known as a Home Node B Gateway (HNB-GW). One HNB-GW can provide network connectivity of several HNB's to a core network.

Conventionally, in a femto-cell network, each HNB has an Iuh connection to a single HNB-GW (Access Point).

Often in a femto-cell network, an access point management system (or HNB management system) is provided which communicates with the access point controller (HNB-GW). This management system is typically configured to manage a large number of access points (HNB's), for example, monitoring, software upgrades, failure management.

Each access point (HNB) goes through a registration procedure in order to establish a communications link with the network access controller (HNB-GW). Conventionally, it does this using a HNB application part (HNB AP) request message. If the registration has been successful, the HNB-GW returns a HNBA P register accept message.

When a user equipment (UE) camps on to a particular HNB, the HNB attempts to register the UE with the HNB-GW by sending a HNBAP UE register request message. The message can contain a UE identity and will be acknowledged with an accepted message via the HNB-GW if the registration is successful.

The HNB monitors the UE via periodic location updates. If a number of location updates are missed, the HNB assumes that the UE is no longer camped on and has left the HNB's′ area of coverage. The HNB then informs the HNB-GW of this occurrence by sending a HNB AP deregister message.

A current industry model is to implement a GSMA one API on one of three places: viz. on the user equipment (for handset applications) or on the femto-cell (for local applications) or on the application Gateway (for external third-party access). The GSMA one API is an application programming interface which has been developed by the GSM (Global System for Mobile Communications) Association. It is intended to be a web service interface. An application developed with one API can obtain information across network operators that support it. It is intended for operation on servers and mobile devices and the first API's to be implemented will be for messaging and location functions. Specifically, version 1 requires “location presence” capability and the ability to send and receive short message services (SMS) and multimedia messaging services (MMS) through the application Gateway using the GSMA one API.

“Presence” services in general permit an individual and equipment which he uses for communication to share information on the state of the individual and that equipment. Such information can include whether the individual and his communication equipment are currently able to communicate with others or engaged on a video call, for example. “Presence” can also include information relating to the location of a user communication equipment.

Location information can be very useful to retailers and advertisers who may wish to communicate with shoppers who are known to be in a certain location at a certain time, a shopping mall for example. Hence, it would be advantageous to provide a means for providing such location presence information. It would also be advantageous to provide a centralized GSMA one API Application Gateway for location presence.

### SUMMARY OF THE INVENTION

Aspects of the invention provide network elements, a cellular communication system and methods therefor as described in the appended claims.

According to a first aspect of the invention, there is provided a method for providing a location presence service in a cellular communication system), the method comprising the steps of;
at an access point located in a designated geographical zone, sending an access point registration message to an access controller,
at the access controller, forwarding the received access point registration message to an access point management system,
in the access point management system, in response to the received access point registration message, sending a flagged acknowledgement message to the access controller,
at the access controller, subsequent to receiving the flagged acknowledgement message, forwarding a wireless communication unit registration message received from an access point located in the designated geographical zone to the access point management system,
and in the access point management system, on receiving the wireless communication unit registration message, generating a location presence notification message in respect of said wireless communication unit.

The solution provides a mechanism to trigger a UE register or deregister message to be sent from the HNB-GW to the access point management system and to keep the location presence capability down at the femto-cell layer.

Hence, the interface between the 3G AC (HNB-GW) and the access point management system is extended beyond registration/deregistration of an access point, disconnection of an access point and updating an access point's Access Control List (ACL) to cover registration and deregistration of user equipments.

In one exemplary embodiment, the interface between the access point management system and the 3G AC may be the so-called Radius (Remote Authentication Dial-in User Service) interface. Radius is a known networking protocol used for managing access to a wireless network or the Internet, for example. It provides authentication and authorization of devices before allowing them access to network services and also provides an accounting function for usage of such services.

According to a second aspect of the invention, there is provided a network element for providing a location presence service in a cellular communication system, the network element being adapted to,
receive an access point registration message via an access controller from an access point located in a designated geographical zone,
in response to receiving the access point registration message, generate a flagged acknowledgement message,
receive a wireless communication unit registration request message via the access controller from the access point,
and in response to receiving the wireless communication unit registration message, generate a location presence notification message in respect of said wireless communication unit.

According to a third aspect of the invention, there is provided a an Access Controller for controlling access to a cellular communication system of a wireless communication unit via an access point, the access controller adapted to receive a wireless communication registration request via an access point and wherein the access controller further comprises a signal processing module for facilitating provision of a location presence service, wherein the signal processing module is adapted to determine whether said registration request has been sent via an access point which is located in a designated geographical zone and if so, to notify an access point management system.

In one embodiment of the invention, the signal processing module for facilitating provision of the location presence service may be implemented in an integrated circuit.

According to a fourth aspect of the invention, there is provided a wireless communication system adapted to support the aforementioned method or adapted to support the aforementioned network element or adapted to support the aforementioned access controller.

According to a fifth aspect of the invention, there is provided a tangible computer program product having executable program code stored thereon for programming processing logic to perform a method for providing a location presence service in a cellular communication system, the tangible computer program product comprising code for attaching a flag to a registration request acknowledgement message.

According to a sixth aspect of the invention, there is provided a tangible computer program product having executable program code stored thereon for programming processing logic to perform a method for providing a location presence service in a cellular communication system, the tangible computer program product comprising code for determining whether a registration request has been sent via an access point in the cellular communication system which is located in a designated geographical zone and if so, to notify an access point management system in the cellular communication system.

The tangible computer program product may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory

These and other aspects, features and advantages of the invention will be apparent from, and elucidated with reference to, the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding.

FIG. 1 illustrates a part of a cellular communication system operating in accordance with an example embodiment.

FIG. 2 is a sequence chart of a method for providing a location presence service according to one embodiment of the invention.

FIG. 3 is a sequence chart of a method for providing a location presence service according to an alternative embodiment of the invention.

### DETAILED DESCRIPTION

The inventive concept finds particular applicability in a cellular communication system that supports any number of overlapping coverage areas, particularly femto-cells. Those skilled in the art, however, will recognise and appreciate that the specifics of this example are merely illustrative of some embodiments and that the teachings set forth herein are applicable to a variety of alternative settings. As such, other alternative implementations within cellular communication networks conforming to different standards are contemplated and are within the scope of the various teachings described.

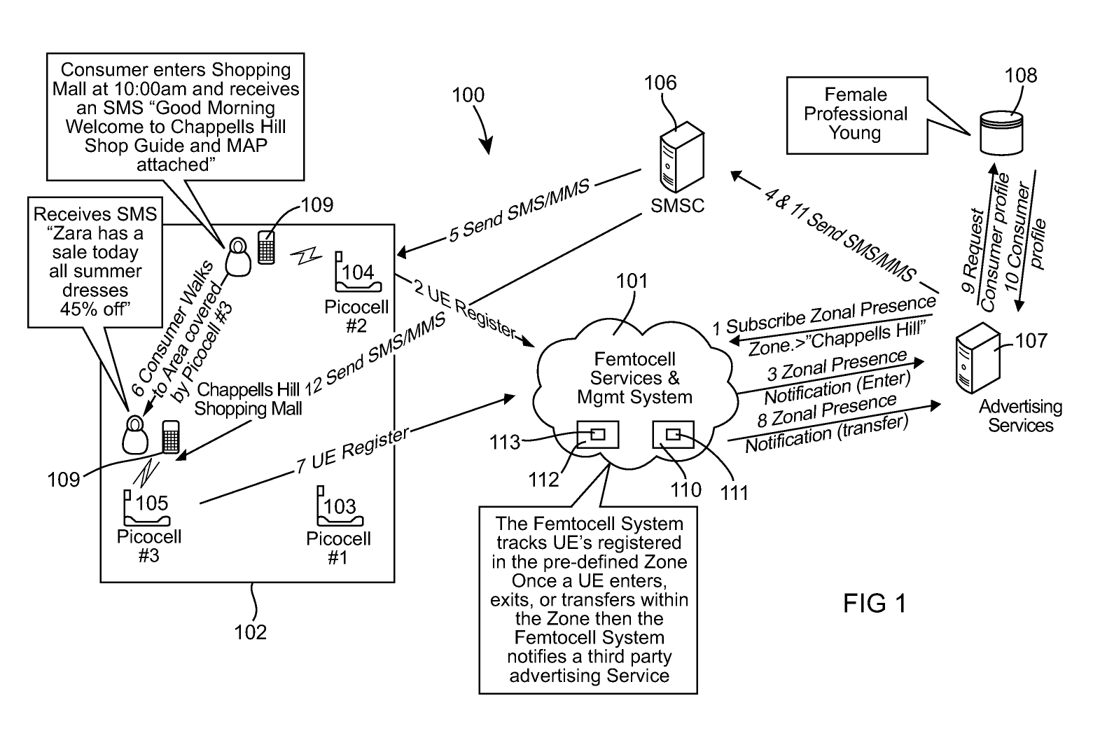

With reference to FIG. 1, a part of a cellular communication system 100 includes a femto-cell services and management system 101. This management system includes the functionality of a 3G network access controller (3G AC) and an access point management system (AMS).

A geographical area, or zone, which in this example is a shopping mall 102 is divided into three picocells 103, 104, 105. Each picocell is served by a 3G access point (3G AP). Communication links exist between each picocell 103, 104, 105 and the femto-cell services and management system 101 and each picocell registers with the system 101 via their respective links. A short message service controller (SMSC) 106 is provided for receiving and sending text/multimedia messages within the cellular communication system 100.

This exemplary embodiment of the invention is arranged for providing location presence information to a commercial enterprise represented by “advertising services” 107 and a database 108. The embodiment also enables the commercial enterprise to send a user (of a user equipment) selective advertising material at an appropriate point in time. The femto-cell services and management system 101 tracks user equipments which are registered in a pre-defined zone, in this case the shopping mall 104. Once a user equipment enters, exits or transfers within the zone, the system 101 notifies the third party advertising service 107.

The femto-cell services and management system 101 operates a zonal presence service to which the advertising service subscribes (step 1). A consumer carrying a user equipment, for example a mobile phone 109, enters the shopping mall at a location covered by the picocell 104. At step 2, the picocell 104 sends a UE register message to the femto-cell services and management system 101. On receipt of this registration message, at step 3, the femto-cell services and management system 101 notifies the advertising service 107 that a customer has entered the mall 102 and provides an identification of the customer, by way of the user equipment identity (IMSI) for example.

The advertising services 107 then arranges for a welcoming text message to be sent to the mobile phone 109 by way of the SMSC 106 (step 4) and the picocell 104 (step 5).

The consumer then moves out of picocell 104 and transfers into picocell 105 (step 6).

Next, picocell 105 registers the mobile phone (UE) 109 with the femto-cell services and management system 101 (step 7). In response, the system 101 notifies the advertising services 107 of the UE transfer (step 8).

At step 9, the advertising services 107 interrogates its database 108 to obtain the profile of the owner of the UE 109. The consumer profile is relayed to the advertising service 107 (step 10) which configures an appropriate advertising message which is sent as a text message via the SMSC 106 and the picocell 105 (step 11 and step 12).

When the 3G AC part of the femto-sell services and management system 101 notifies the AMS part of the system 101 that an access point (one of picocells 103, 104, 105) is registering, the AMS sends back an accept message to which is attached an additional “zonal flag.” This zonal flag is used by the 3G AC in such a way so that whenever a UE registers or de-registers on an AP (picocell 103, 104, 105) which has had a zonal flag activated against it, then the 3G AC notifies the AMS.

In this way, an access point management system can act as a centralized GSMA one API application Gateway for location presence.

The femto-cell services and management system 101 includes an access controller (3GAC) 110 which incorporates a signal processing module 111 for facilitating the location presence service and particularly for determining whether UE registration requests have come from a designated zone.

The femto-cell services and management system 101 also includes an access point management system (AMS) 112 which includes a network element 113 which is configured to facilitate the location presence service as described herein.

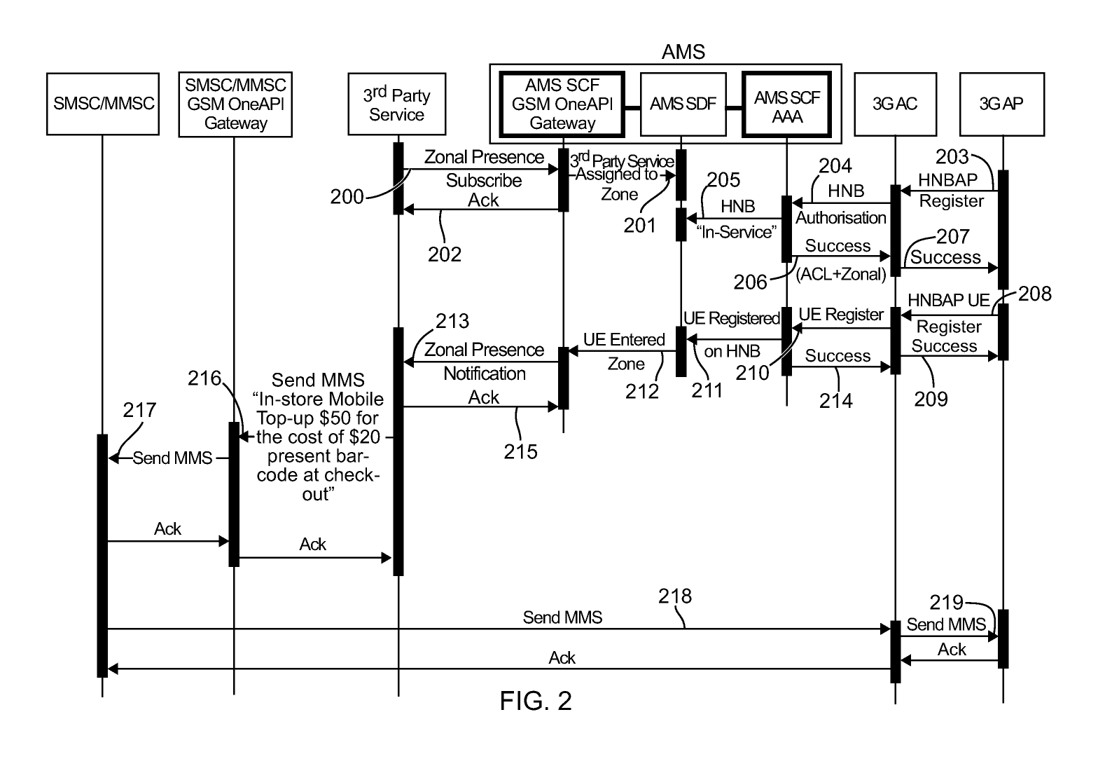

A zonal presence notification method within a femto/pico-cell environment will now be described in more detail with reference to FIG. 2.

At step 200, a third party service sends a zonal presence subscribe request to an access point management system AMS, whereupon at step 201, the third-party service is assigned to a zone at step 201.

At step 202, the AMS sends a subscribe acknowledgement back to the third-party service.

At step 203, a 3G AP (HNB) sends a HNBAP register request message to the 3G AC. Subsequently, the 3G AC sends a HNB authorization message (step 204) to an authorization, authentication and accounting (AAA) part of the AMS which, in turn, generates a HNB. “in-service” notification (step 205).

At step 206, the AMS replies to the 3G AC with a success message which incorporates a ACL and a zonal flag in respect of the registered 3G AP.

When a UE enters the coverage area of the 3G AP, the 3G AP registers the UE with the 3G AC by way of a HNBAP UE register request message (step 208) and receives a success message back (step 209).

Because a zonal flag has been associated with the 3G AP, the 3G AC is triggered into sending a UE register message to the AMS (step 210). This notification is cascaded (steps 211, 212, 213 to the third-party service as a zonal presence notification.

Notification of successful registration is sent from the AMS to the 3G AC (step 214) and an acknowledgement of receipt of the zonal presence notification is made by the third-party service (215).

In response to the zonal presence notification, the third-party service may decide to instigate the transmission of MMS messages with advertising content to the UE. This can be done via a SMSC-GSMA one API interface and a SMSC (steps 216-219).

The method as described with reference to FIG. 2 can be implemented by one or more network elements with the ability to intercept a HNBAP UE register or deregister message and to send additional registrations and deregistrations across the Radius interface for the purposes of location presence. Specifically, a network element has the ability to notify a 3G access controller (or HNB-GW) that a registered access point is “zonal” across the Radius interface between the AMS and the 3G AC.

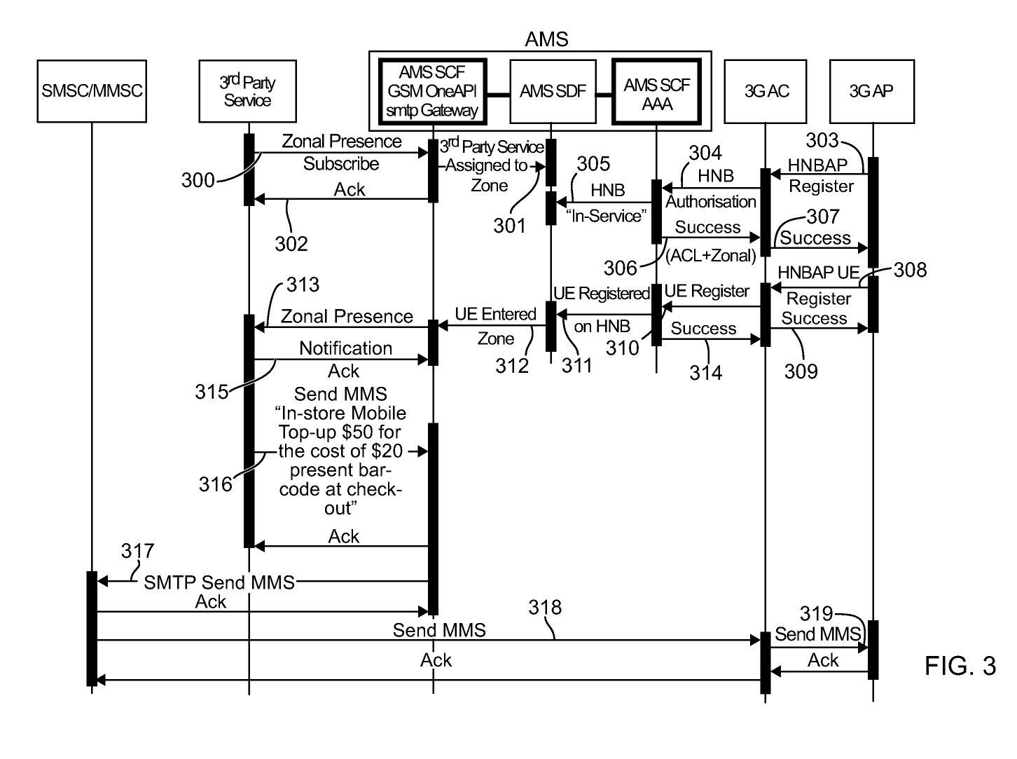

A zonal presence notification method within a femto/pico-cell environment with SMSC/MMSC (multimedia message service control) interface will now be described with reference to FIG. 3.

At step 300, a third-party service sends a zonal presence subscribe request to an access point management system AMS, whereupon at step 301, the third-party service is assigned to a zone.

At step 302, the AMS sends a subscribe acknowledgement back to the third-party service.

At step 303, a 3G AP (HNB) sends a HNBAP register request message to the 3G AC. Subsequently, the 3G AC sends a HNB authorization message (step 304) to an Authorisation, Authentication and Accounting (AAA) part of the AMS, which in turn, generates a HNB “in-service” notification (step 305).

At step 306, the AMS replies to the 3G AC with a success message which incorporates a ACL and a zonal flag in respect of the registered 3G AP.

The 3G AC then sends a (registration) success message (step 307) to the 3G AP.

When a UE enters the coverage area of the 3G AP, the 3G AP registers the UE with the 3G AC by way of a HNBAP UE register request message (step 308) and receives a success message back (step 309).

Because a zonal flag has been associated with the 3G AP, the 3G AC is triggered into sending a UE register message to the AMS (step 310). This notification is cascaded (steps 311, 312, 313) to the third-party service as a zonal presence notification.

Notification of successful registration is sent from the AMS to the 3G AC (step 314) and an acknowledgement of receipt of the zonal presence is made by the third-party services (step 315).

The third-party services may then choose to send a MMS message with advertising content to the UE by way of the AMS and a MMSC (steps 316-319).

The method as described with reference to FIG. 3 can be implemented by one or more network elements having the ability to notify an access controller that an access point is a zonal access point on registration. The network element(s) may also have the capability to trigger UE registration and deregistration requests in respect of zonal access points. The network element(s) may further act as centralized location presence servers which expose location presence information to third-party developers utilising the GSMA one API.

The signal processing functionality of the embodiments of the invention, particularly the signal processing module 111 in the Access Controller 110 and the network element 113 of the Access Point Management System 112 may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor comprising the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organisation.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices. Thus, the elements and components of an embodiment of the invention may be physically, functionally and logically implemented in any suitable way. Indeed, the functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

We claim:

1. A method for providing a location presence service in a cellular communication system, the method comprising the steps of;
at an access point located in a designated geographical zone, sending an access point registration message to an access controller,
at the access controller, forwarding the received access point registration message to an access point management system,
in the access point management system, in response to the received access point registration message, sending a flagged acknowledgement message to the access controller,
at the access controller, subsequent to receiving the flagged acknowledgement message, forwarding a wireless communication unit registration message received from an access point located in the designated geographical zone to the access point management system,
and in the access point management system on receiving the wireless communication unit registration message, generating a location presence notification message in respect of said wireless communication unit.

2. The method of claim 1 wherein the access point registration message comprises a HNBAP (Home Node B Application Part) register request message.

3. The method of claim 1 wherein the wireless communication unit registration message comprises a HNBAP UE register request message.

4. The method of claim 1 wherein the flagged acknowledgement message comprises a zonal flag in respect of the access point.

5. The method of claim 1 wherein the flagged acknowledgement message includes an access control list (ACL).

6. A network element for providing a location presence service in a cellular communication system, the network element being adapted to,
receive an access point registration message via an access controller from an access point located in a designated geographical zone,
in response to receiving the access point registration message, generate a flagged acknowledgement message,
receive a wireless communication unit registration request message via the access controller from the access point,
and in response to receiving the wireless communication unit registration message, generate a location presence notification message in respect of said wireless communication unit.

7. The network element of claim 6 wherein the flagged acknowledgement message comprises a registration request acknowledgement message with a zonal flag attached thereto.

8. An Access Controller for controlling access to a cellular communication system of a wireless communication unit via an access point, the access controller adapted to receive a wireless communication registration request via an access point and wherein the access controller further comprises a signal processing module for facilitating provision of a location presence service, wherein the signal processing module is adapted to determine whether said registration request has been sent via an access point which is located in a designated geographical zone and if so, to notify an access point management system.

9. The access controller of claim 8 wherein the signal processing module is adapted to determine whether the wireless communication request has been received from an access point which has a zonal flag activated against it.

10. The access controller of claim 8 wherein the signal processing module for facilitating provision of a location presence service is implemented in an integrated circuit.
